(19) United States
(12) Patent Application Publication
(10) Pub. No.: US 2002/0166055 A1
(43) Pub. Date: Nov. 7, 2002

(54) Secure pin entry into a security chip

(75) Inventors: David Carroll Challener, Raleigh, NC (US); David Robert Safford, Brewster, NY (US); James Patrick Hoff, Raleigh, NC (US)

Correspondence Address: BRACEWELL & PATTERSON, L.L.P., Intellectual Property Law, P.O. Box 969, Austin, TX, 78767-0969, US

(73) Assignee: International Business Machines Corporation

(21) Appl. No.: 09/849,079

(22) Filed: May 4, 2001

(51) Int. Cl. H04L 9/32; G06F 12/14

(52) U.S. Cl. 713/193

(57) ABSTRACT

A personal computer furnishes a secure path for a security chip of the personal computer for entry of a personal identification number code (PIN). The path is not sniffable or surreptitiously detectable by software. The security chip is removably mounted on a daughter card rather than hardwired to the motherboard of the personal computer. With proper authorization, an interposer may be inserted between the daughtercard and the motherboard. When the PIN becomes necessary, it need not be entered through a keyboard and transmitted to the daughtercard over a bus where it is capable of surreptitious detection or interception. The PIN is instead entered directly from a keypad into the daughtercard.

### BACKGROUND OF THE INVENTION

1. Technical Field

The present invention relates to personal computer system security features, and more particularly to personal computer systems which provide for secure entry of a personal identifier number or PIN code into a security chip.

2. Description of the Related Art

A number of desktop computer systems have been furnished with a security chip which permitted secure digital signature usage. It has been possible with these systems in some cases in effect to guarantee that a digital signature originated from a specific associated desktop computer platform or unit. However, so far as is known, there has been no method to insure that use of the digital signature and the associated desktop platform was being made by or with the authority of the possessor or accredited person for that particular digital signature.

One solution proposed for this was to require that a personal identification number or PIN code be entered when use was attempted to be made of a key for access to the security chip. However, this further solution was still susceptible to attack if an unauthorized person or attacker had physical access to the key entry area. Such an attacker or hacker could use program methods of the type known in the art as a “Trojan horse.” With techniques like this, the key could be surreptitiously detected or sniffed for later unauthorized retrieval and use.

From the foregoing, it can be appreciated that a need exists for a personal computer system that permits entry of a personal identifier code into a security chip in a manner that prevents surreptitious detection of that code by others or unauthorized use of that code.

### SUMMARY OF THE INVENTION

It is therefore an object of the invention to provide a method and system for secure entry of a personal identifier code into a computer system.

It is another object of the invention to provide a method and system for secure entry of a personal identifier code for a security chip of a personal computer system independently of the computer system bus.

It is still another object of the invention to provide a method and system for entry of a personal identifier code to a security chip of a computer system in a manner that protects against surreptitious detection of the code over the system bus.

The above and other objects are achieved as is now described. A computer system and method are provided for secure entry of a personal identifier code or PIN into a security chip of the computer system. The code is entered by a user when one of the programs operating in the computer requires entry of such a code. The code may be entered through the computer system keyboard or other form of authorization identifier. An interposer is located in the computer system connected between the code input and the security chip. An interface adapter in the computer system activates the interposer when the personal identifier code is required. The interposer then receives the personal identifier code and transfers the code to the security chip independently of the system bus, without the code appearing on the system bus. The present invention thus provides a secure path to the security chip in a manner that the personal identifier code is not surreptitiously detectable or sniffable because it is not present on the system bus during its presentation or entry.

The foregoing and other objects and advantages of the present invention will be apparent to those skilled in the art, in view of the following detailed description of the preferred embodiment of the present invention, taken in conjunction with the appended claims and the accompanying drawings

### BRIEF DESCRIPTION OF THE DRAWINGS

FIG. 1 is an isometric view of a personal computer system in which a preferred embodiment of the present invention may be implemented.

FIG. 2 is a schematic diagram of a representative hardware environment of the personal computer system of FIG. 1.

FIG. 3 is a schematic diagram of system security portions of the personal computer system of FIG. 3.

FIG. 4 is a flow chart indicating the processing of user requests for secure entry of data according to the present invention.

### DETAILED DESCRIPTION OF THE PREFERRED EMBODIMENT

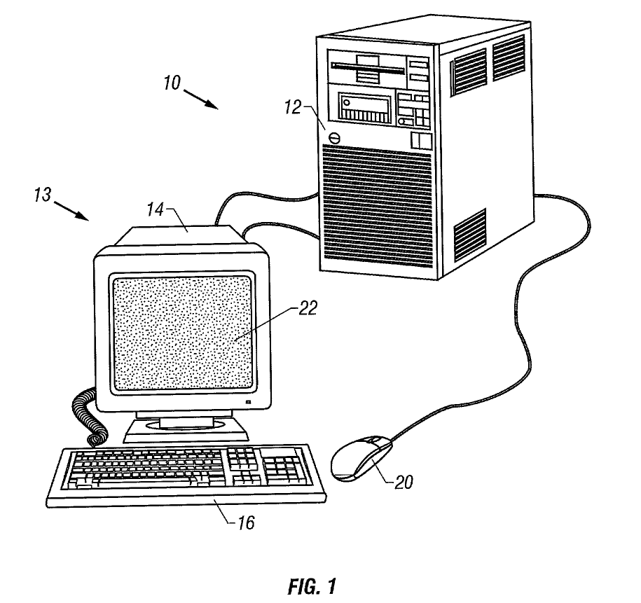

With reference now to the figures and in particular with reference to FIG. 1, there is depicted a pictorial representation of a data processing system 10 with which the present invention may advantageously be utilized. As illustrated, data processing system 10 comprises a workstation 12 to which one or more nodes 13 are connected. The workstation 12 is typically one of a set connected together in a suitable network, such as a local area network or LAN, wide area network or WAN or other computer form of computer network or information interchange medium. Workstation 12 preferably comprises a high performance multiprocessor computer, such as the RISC System/6000 or AS/400 computer systems available from International Business Machines Corporation (IBM). Workstation 12 preferably includes nonvolatile and volatile internal storage for storing software applications. As depicted, nodes 13 are comprised of a wide variety of types display device 14, a keyboard 16, and a mouse 20. Any suitable software applications may be stored and executed within workstation 12 preferably including software to display a graphic user interface (GUI) within display screen 22 of display device 14 with which a computer user/operator can interact using a keyboard 16 and mouse 20. Thus, by entering appropriate inputs utilizing keyboard 16 and mouse 20, the computer user may perform any work which the software applications are capable of implementing. With the present invention a user of the workstation 12 is provided the ability to enter an individualized personal identifier code or PIN in a manner that permits surreptitious detection or sniffing by unauthorized users or hackers according to the method described further herein below.

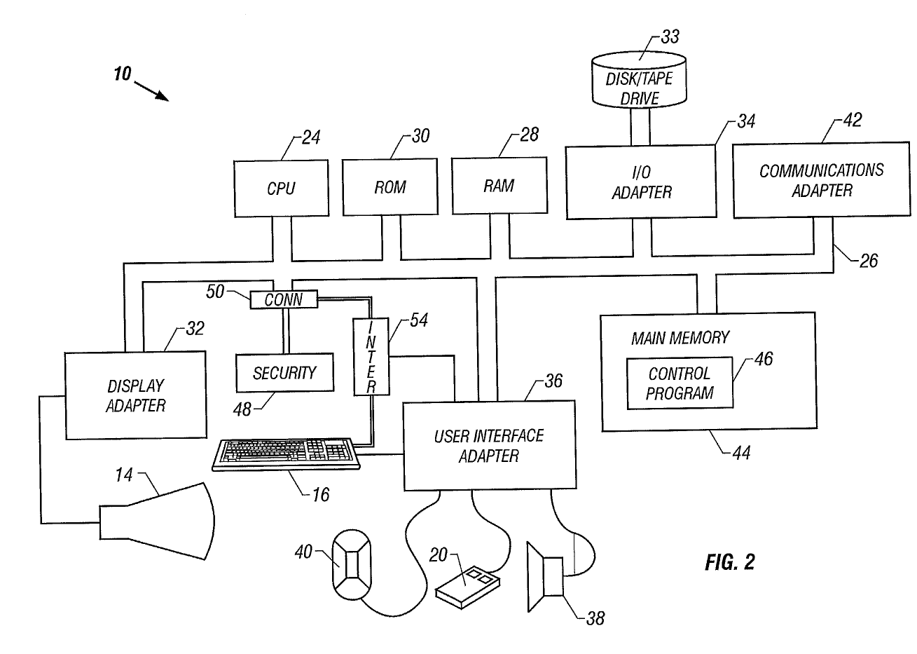

FIG. 2 depicts a representative hardware environment of data processing system 10 illustrated in FIG. 1. In FIG. 1 and FIG. 2, like parts are identified by like numbers. Data processing system 10 in FIG. 2 is thus a configuration that includes all functional components of a computer and its associated hardware. Data processing system 10 includes a Central Processing Unit (“CPU”) 24, such as a conventional microprocessor, and a number of other units interconnected in the conventional manner via system bus 26 on a common board known as a motherboard. CPU 24 includes a portion of data processing system 10 that controls the operation of the entire computer system, including executing the arithmetical and logical functions contained in a particular computer program. Although not depicted in FIG. 2, CPUs such as CPU 24 typically include a control unit that organizes data and program storage in a computer memory and transfers the data and other information between the various parts of the computer system. Such CPUs also generally include an arithmetic unit that executes the arithmetical and logical operations, such as addition, comparison, multiplications and so forth. Such components and units of data processing system 10 can be implemented in a system unit such as workstation 12 of FIG. 1.

Data processing system 10 further includes random-access memory (RAM) 28, read-only memory (ROM) 30, display adapter 32 for connecting system bus 26 to display device 14, and I/O adapter 34 for connecting peripheral devices (e.g., disk and tape drives 33) to system bus 26. RAM 28 is a type of memory designed such that the location of data stored in it is independent of the content. Also, any location in RAM 28 can be accessed directly without having to work through from the beginning. ROM 30 is a type of memory that retains information permanently and in which the stored information cannot be altered by a program or normal operation of a computer.

Display device 14 is the visual output of data processing system 10. Display device 14 can be a cathode-ray tube (CRT) based video display well-known in the art of computer hardware. However, with a portable or notebook-based computer, display device 14 can be replaced with a liquid crystal display (LCD) based or gas plasma-based flat-panel display. Data processing system 10 further includes user interface adapter 36 for connecting keyboard 16, mouse 20, speaker 38, microphone 40, and/or other user interface devices, such as a touch-screen device (not shown), to system bus 26. Speaker 38 is one type of audio device that may be utilized in association with the method and system provided herein to assist diagnosticians or computer users in analyzing data processing system 10 for system failures, errors, and discrepancies. Communications adapter 42 connects data processing system 10 to a computer network. Although data processing system 10 is shown to contain only a single CPU and a single system bus, it should be understood that the present invention applies equally to computer systems that have multiple CPUs and to computer systems that have multiple buses that each perform different functions in different ways.

Data processing system 10 also includes an interface that resides within a machine-readable media to direct the operation of data processing system 10. Any suitable machine-readable media may retain the interface, such as RAM 28, ROM 30, a magnetic disk, magnetic tape, or optical disk (the last three being located in disk and tape drives 33). Any suitable operating system and associated interface (e.g., Microsoft Windows) may direct CPU 24. For example, the AIX operating system and AIX Windows windowing system can direct CPU 24. The AIX operating system is IBM's implementation of the UNIX.TM. operating system. Other technologies also can be utilized in conjunction with CPU 24, such as touch-screen technology or human voice control.

Those skilled in the art will appreciate that the hardware depicted in FIG. 2 may vary for specific design and simulation applications. For example, other peripheral devices such as optical disk media, audio adapters, or chip programming devices, such as PAL or EPROM programming devices well-known in the art of computer hardware and the like, may be utilized in addition to or in place of the hardware already depicted. In addition, main memory 44 is connected to system bus 26, and includes a control program 46. Control program 46 resides within main memory 44, and contains instructions that, when executed on CPU 24, carries out the operations depicted and described herein.

A security chip 48 that allows for digital signature is connected to the system bus 26. The security chip 48 is removably mounted, being connected by plugging into a separate card or board 50 accessible only when cabinet 52 (FIG. 1) of workstation 12 is opened. An interposer circuit or card 54 (FIG. 2) is also located with security chip 48 on the motherboard between connector 50 and the motherboard on which other components of FIG. 2 are located. The interposer or blocker card 54 permits, as will be described in more detail below, a user to enter personal identifier codes or PIN'S without such information being present on or accessible from system bus 26.

The interposer circuit 54 is also connected to the user interface adapter 36 to receive a switching function signal when a user indicates a desire to enter an individualized PIN or identifier code.

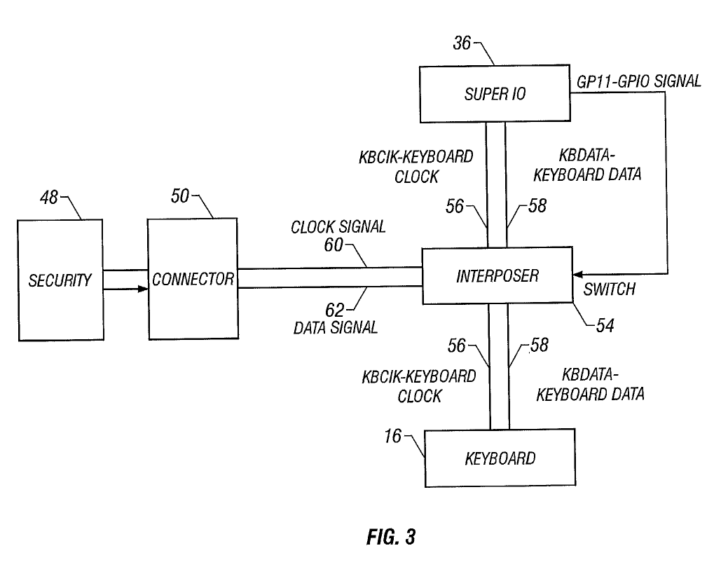

Turning to FIG. 3, for operation according to the present invention, cabinet 52 of workstation 12 is opened and the interposer card 54 inserted for electrical connection between the security card 48 and the components of FIG. 2 on the motherboard. Other components of FIG. 2 are not shown in FIG. 3 for ease of viewing the components illustrated in FIG. 3.

The interposer card 54 may be an application specific integrated circuit or ASIC which provides a direct electrical passage there through except for the system bus clock signal and system bus data signal and system bus data signal on conductors or conductive members 56 and 58, as shown. The system bus clock signal on conductor 56 and system bus data signals on conductor 58 are also passed directly through interposer card 54.

The interposer card 54 is electrically connected to exchange keyboard clock signals with keyboard 16 over conductor member or conductor 56 and to receive keyboard data signals over conductor 58. The interposer card 54 may be any suitably coded or wired circuit component, such as an Application Specific Integrated Circuit, or ASIC. The interposer card 54 during normal operation performs a pass through function, transferring the keyboard data signals and keyboard clock signals between the keyboard 16 and the user interface adapter 36. The user interface adapter 36 in its preferred form is a SUPER I/O available from Intel Corporation.

The interposer card 54 connected to an output terminal providing a GPIO signal from user interface adapter 36 to receive such a signal when computer programs operating in workstation 12 either require or permit entry of a PIN or personal identifier code.

The interposer card 54 contains appropriate conventional logic or gating which performs two concurrent operations in response to presence of the GPIO signal from user interface adapter or input/output 36. First, passage of the keyboard clock signals and keyboard data signals between the keyboard 16 and user interface adapter 36 is blocked. The second concurrent operation is that keyboard clock signals on conductor 56 and keyboard data signals on conductor 58 are routed instead via clock conductor 60 and data conductor 62, respectively, to security chip 48 via connector 50.

It should be understood that the interposer card may be implemented through an ASIC, as discussed above, or in other ways, as well. For example, the interposer function and operation may be performed in a PLD, or programmable logic device, or in a microcontroller, as well.

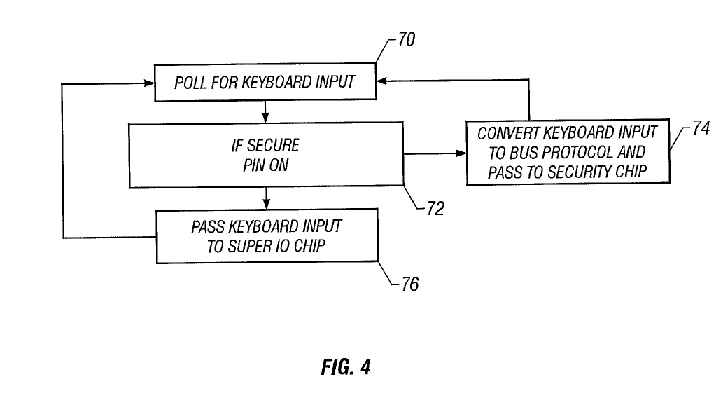

FIG. 4 illustrates a process for implementing the transfer of a personal identifier code according to the present invention from a secure entry input, such as shown at 16, to the security chip 48. A step 70 polls the keyboard 16 for keyboard input. Step 72 next verifies whether the secure personal identifier code or PIN feature is activated. This is indicated as a positive or affirmative by the state of the GPIO signal from user interface adapter 36.

If an affirmative answer is indicated during step 72, step 74 is performed to convert the keyboard input from their routing for interface adapter 36 instead to a route to security chip 48 by way of connector 50. Step 70 is then repeated after step 74.

If during step 72 a negative answer or response is indicated, step 76 is performed instead of step 74. During step 74, the inputs to keyboard 16 are passed from keyboard 16 through to interface adapter 36. Step 70 is then repeated after step 76.

In this manner, at times when the PIN code is necessary, a direct communication channel is provided from the keyboard 16 to security chip 48. In this manner, the PIN code is transmitted between keyboard 16 and security chip 48 independently of system bus, without being present on system bus 26, where it would be susceptible to sniffing or surreptitious detection.

It should be recognized that other interfaces than keyboard 16 may be used according to the present invention for entry of the PIN or code. For example, a separate keypad, a fingerprint reader or a coded card reader could be used to receive the user's PIN authorizing code input or information in several forms. Further, the signal controlling data flow between the interposer 54 and PIN entry keyboard can be routed through the input/output adapter 36. In this way, computer system 10 would permit user software to require a secure keyboard communication channel by asserting the GPIO signal.

It can thus be seen that the present invention is easily adapted for use and installation in general purpose, commercially available computers for those purchasers and users who are concerned with provision of increased security. It also provides a reliable path for entry of pin codes which is not via the system bus and would thus be sniffable or surreptitiously detectable.

It is important to note that, while the present invention has been, and will continue to be, described in the context of a fully functional computer system, those skilled in the art will appreciate that the present invention is capable of being distributed as a program product in a variety of forms, and that the present invention applies equally regardless of the particular type of signal-bearing media utilized to actually carry out the distribution. Examples of signal-bearing media include: recordable-type media, such as floppy disks, hard disk drives, and CD ROMs, and transmission-type media such as digital and analog communication links.

While the invention has been shown or described in only some of its forms, it should be apparent to those skilled in the art that it is not so limited, but is susceptible to various changes without departing from the scope of the invention.

What is claimed is:

1. A computer system comprising:
a processor;
machine readable storage media for storing programs performable by the processor;
input means for receiving input from a user;
a display device for providing visual output from the software applications to the user;
a system bus connecting the processor to the display device and the input means;
an interface adapter for transferring input from the user at the input means to the system bus;
a security chip requiring a personal identifier code from the user for performance of at least one of the programs in the storage media; and
interposer means for routing the personal identifier code from the input means to the security chip independently of the system bus.

2. The computer system of claim 1, wherein the processor are located on a motherboard in the computer system.

3. The computer system of claim 2, wherein the interposer means and the security chip are located separately from the motherboard in the computer system.

4. The computer system of claim 2, wherein the interposer means and the security chip are located separately on a separate card from the motherboard in the computer system.

5. The computer system of claim 2, wherein the interposer means is located separately on a separate board from the motherboard in the computer system.

6. The computer system of claim 1, wherein the interposer means comprises:
interposer means for routing the personal identifier code directly from the input means to the security chip.

7. The computer system of claim 1, wherein:
the user interface adapter connects the interposer means to the security chip.

8. The computer system of claim 1, wherein the interposer means comprises:
interposer means for routing the personal identifier code from the input means to the user interface adapter.

9. The computer system of claim 1, wherein data and clock signals are provided between the input means and the user interface adapter and the interposer means further comprises:
means for blocking the data and clock signals between the input means and the user interface adapter.

10. The computer system of claim 1, wherein the input means comprises a keyboard for entry of the personal identifier code.

11. The computer system of claim 1, wherein the input means comprises:
a keyboard for entry of data; and
a keypad for entry of the personal identifier code.

12. The computer system of claim 1, wherein the input means comprises:
a keyboard for entry of data; and
a fingerprint reader for scanning a user fingerprint to verify an authorized fingerprint as the personal identifier code.

13. The computer system of claim 1, wherein the input means comprises:
a keyboard for entry of data; and
a card reader for scanning a user card to verify an authorized card as the personal identifier code.

14. A computer system comprising:
a processor;
machine readable storage media for storing programs performable by the processor;
input means for receiving input from a user;
a display device for providing visual output from the software applications to the user;
a system bus connecting the processor to the display device and the input means;
an interface adapter for transferring input from the user at the input means to the system bus
a security chip requiring a personal identifier code from the user for performance of at least one of the programs in the storage media;
a direct communication channel for transferring user input from the input means to the security chip; and
interposer means for routing the personal identifier code over the direct communication channel to the security chip.

15. The computer system of claim 14, wherein the processor are located on a motherboard in the computer system.

16. The computer system of claim 15, wherein the interposer means and the security chip are located separately from the motherboard in the computer system.

17. The computer system of claim 16, wherein the interposer means and the security chip are located separately on a separate card from the motherboard in the computer system.

18. The computer system of claim 16, wherein the interposer means is located separately on a separate board from the motherboard in the computer system.

19. The computer system of claim 14, wherein data and clock signals are provided between the input means and the user interface adapter and the interposer means further comprises:
means for blocking the data and clock signals between the input means and the user interface adapter.

20. The computer system of claim 14, wherein the input means comprises a keyboard for entry of the personal identifier code.

21. The computer system of claim 14, wherein the input means comprises:
a keyboard for entry of data; and
a keypad for entry of the personal identifier code.

22. The computer system of claim 14, wherein the input means comprises:
a keyboard for entry of data; and
a fingerprint reader for scanning a user fingerprint to verify an authorized fingerprint as the personal identifier code.

23. The computer system of claim 14, wherein the input means comprises:
a keyboard for entry of data; and
a card reader for scanning a user card to verify an authorized card as the personal identifier code.

24. A method of transferring a personal identifier code to a security chip in a personal computer system comprising the steps of:
entering the personal identifier code in a security entry input to the personal computer in response to a request from a processor of the computer over a computer system bus;
receiving the personal identifier code in an interposer connected between the security entry input and the security chip; and
transferring the personal identifier code from the interposer independently of the computer system bus.

25. The method of claim 24, wherein the security entry input comprises a keyboard for entry of the personal identifier code.

26. The method of claim 24, wherein the security entry input comprises:
a keyboard for entry of data; and
a keypad for entry of the personal identifier code.

27. The method of claim 24, wherein the security entry input comprises:
a keyboard for entry of data; and
a fingerprint reader for scanning a user fingerprint to verify an authorized fingerprint as the personal identifier code.

28. The method of claim 24, wherein the security entry input comprises:
a keyboard for entry of data; and
a card reader for scanning a user card to verify an authorized card as the personal identifier code.

29. The method of claim 24, wherein:
the step of transferring comprises transferring the personal identifier code over a direct communication channel from the security entry input to the security chip.
